(19) United States
(12) Patent Application Publication
(10) Pub. No.: US 2014/0131329 A1
(43) Pub. Date: May 15, 2014

(54) HYBRID POWERED ARC WELDER

(71) Applicant: LINCOLN GLOBAL, INC., City of Industry, CA (US)

(72) Inventor: Andreu P. Meckler, Mentor, OH (US)

(73) Assignee: LINCOLN GLOBAL, INC., City of Industry, CA (US)

(21) Appl. No.: 13/792,555

(22) Filed: Mar. 11, 2013

Related U.S. Application Data
(60) Provisional application No. 61/725,667, filed on Nov. 13, 2012.

(51) Int. Cl. B23K 9/10

(52) U.S. Cl. CPC B23K 9/1006
USPC 219/130.1

(57) ABSTRACT

A welding power supply includes a switching type power converter. A welding electrode is connected to the power converter to receive electrical energy therefrom and produce an electric arc. An engine-generator is connected to the welding power supply to supply electrical energy for producing the arc. The engine-generator comprises a plurality of armature windings, and a field winding. A battery is connected to the welding power supply to simultaneously supply further electrical energy for producing the arc, and to receive electrical energy from the engine-generator through the power supply to recharge the battery. A sensor senses battery voltage and/or current, and outputs a signal during recharging corresponding to the battery voltage and/or current. A field controller is connected to the field winding and to the sensor. The field controller receives the signal from the sensor and automatically adjusts a level of current flow through the field winding during recharging based on the signal from the sensor.

### CROSS-REFERENCE TO RELATED APPLICATIONS

Benefit of U.S. Provisional Patent Application Ser. No. 61/725,667 filed Nov. 13, 2012, is hereby claimed and the disclosure incorporated herein by reference.

### BACKGROUND OF THE INVENTION

1. Field of the Invention

The present invention relates to hybrid powered arc welders having both a generator and a battery bank for supplying electrical power to the welder.

2. Description of Related Art

Hybrid powered arc welders can include a battery bank for supplying electrical power to the welder. The welder can be powered solely from the battery bank, solely from a generator, or by the generator and battery bank simultaneously (e.g., for peak shaving). In addition to having welding power and control circuitry and engine-generator control circuitry, hybrid powered arc welders include battery charging circuitry for charging the battery bank from the electrical power supplied by the generator. The charging circuitry increases the cost and complexity of the welder. It would be desirable to minimize the amount of circuitry in a hybrid welder that is dedicated to charging the battery bank.

### BRIEF SUMMARY OF THE INVENTION

The following summary presents a simplified summary in order to provide a basic understanding of some aspects of the systems and methods discussed herein. This summary is not an extensive overview of the systems and methods discussed herein. It is not intended to identify critical elements or to delineate the scope of such systems and methods. Its sole purpose is to present some concepts in a simplified form as a prelude to the more detailed description that is presented later.

Example aspects and embodiments of the present invention are summarized below. It is to be appreciated that the example aspects and/or embodiments may be provided separately or in combination with one another.

In accordance with one aspect of the present invention, provided is a welding power supply including a switching type power converter. A welding electrode is operatively connected to the switching type power converter to receive electrical energy from the switching type power converter and produce an electric arc from the arc welding system. An engine-generator is operatively connected to the welding power supply to supply electrical energy to the welding power supply for producing the arc. The engine-generator comprises a plurality of armature windings for supplying the electrical energy to the welding power supply, and a field winding. A battery is operatively connected to the welding power supply to simultaneously supply further electrical energy to the welding power supply for producing the arc, and to receive electrical energy from the engine-generator through the welding power supply to recharge the battery. A sensor is configured to sense at least one of battery voltage and battery current and to output a signal during battery recharging corresponding to the at least one of battery voltage and battery current. A field controller is operatively connected to the field winding of the engine-generator and to the sensor. The field controller is configured to receive the signal from the sensor and to automatically adjust a level of current flow through the field winding during the battery recharging based on the signal from the sensor.

In certain embodiments, the field controller provides a pulse modulated signal to the field winding to control the level of current flow through the field winding. In certain embodiments, the sensor is configured to sense battery current, and the field controller is configured to determine that the battery is recharging from a flow direction of the battery current. In certain embodiments, the field controller is configured to control the level of current flow through the field winding during the battery recharging based on one of a first field current level corresponding to a first recharging rate of the battery and a second field current level corresponding to second recharging rate of the battery, wherein the first field current level is greater than the second field current level and the first recharging rate is faster than the second recharging rate. In further embodiments, the first recharging rate and the second recharging rate are user-selectable recharging rates. In further embodiments, the first recharging rate exceeds a discharging rate of the battery during welding. In further embodiments, the second recharging rate is approximately equal to a discharging rate of the battery during welding. In further embodiments, the switching type power converter comprises a rectifier, a switching circuit and a DC bus connecting the rectifier and the switching circuit, wherein the battery is connected to the DC bus, and a voltage level of the DC bus due to excitation of the armature windings by the field winding at the first field current level is greater than the voltage level of the DC bus due to excitation of the armature windings by the field winding at the second field current level. In further embodiments, the arc welding system includes a temperature sensor operatively connected to the field controller to provide a temperature signal to the field controller, wherein the field controller is configured to automatically select one of the first field current level corresponding to the first recharging rate of the battery and the second field current level corresponding to the second recharging rate of the battery based on the temperature signal, and to control the level of current flow through the field winding during battery recharging based on the selected one of the first field current level and the second field current level. In still further embodiments, the field controller stores a temperature threshold and compares the temperature signal to the temperature threshold, and automatically selects said one of the first field current level and the second field current level based on a result of comparing the temperature signal to the temperature threshold.

In accordance with another aspect of the present invention, provided is a welding power supply including a switching type power converter. A welding electrode is operatively connected to the switching type power converter to receive electrical energy from the switching type power converter and produce an electric arc from the arc welding system. An engine-generator is operatively connected to the welding power supply to supply electrical energy to the welding power supply for producing the arc. The engine-generator comprises a plurality of armature windings for supplying the electrical energy to the welding power supply, and a field winding. A battery is operatively connected to the welding power supply to simultaneously supply further electrical energy to the welding power supply for producing the arc, and to receive electrical energy from the engine-generator through the welding power supply to recharge the battery. A sensor is configured to sense at least one of battery voltage and battery current and to output a signal during battery recharging corresponding to the at least one of battery voltage and battery current. A field controller is operatively connected to the field winding of the engine-generator and to the sensor. The field controller is configured to receive the signal from the sensor and to control a level of current flow through the field winding during the battery recharging based on the signal from the sensor, wherein the field controller is configured to control the level of current flow through the field winding during the battery recharging to be one of a first field current level corresponding to a first recharging rate of the battery and a second field current level corresponding to second recharging rate of the battery. The first field current level is greater than the second field current level and the first recharging rate is faster than the second recharging rate.

In certain embodiments, the field controller provides a pulse modulated signal to the field winding to control the level of current flow through the field winding. In certain embodiments, the sensor is configured to sense battery current, and the field controller is configured to determine that the battery is recharging from a flow direction of the battery current. In certain embodiments, the first recharging rate and the second recharging rate are user-selectable recharging rates. In certain embodiments, the first recharging rate exceeds a discharging rate of the battery during welding. In certain embodiments, the second recharging rate is approximately equal to a discharging rate of the battery during welding. In certain embodiments, the switching type power converter comprises a rectifier, a switching circuit and a DC bus connecting the rectifier and the switching circuit, wherein the battery is connected to the DC bus, and a voltage level of the DC bus due to excitation of the armature windings by the field winding at the first field current level is greater than the voltage level of the DC bus due to excitation of the armature windings by the field winding at the second field current level. In certain embodiments, the arc welding system further comprises a temperature sensor operatively connected to the field controller to provide a temperature signal to the field controller, wherein the field controller is configured to automatically select one of the first field current level corresponding to the first recharging rate of the battery and the second field current level corresponding to the second recharging rate of the battery based on the temperature signal, and to control the level of current flow through the field winding during battery recharging based on the selected one of the first field current level and the second field current level. In further embodiments, the field controller stores a temperature threshold and compares the temperature signal to the temperature threshold, and automatically selects said one of the first field current level and the second field current level based on a result of comparing the temperature signal to the temperature threshold.

In accordance with another aspect of the present invention, provided is a method of controlling battery recharging in a hybrid powered arc welding system. The method includes the step of providing the arc welding system. The arc welding system comprises a welding power supply comprising a switching type power converter; a welding electrode operatively connected to the switching type power converter; an engine-generator operatively connected to the welding power supply, the engine-generator comprising a plurality of armature windings and a field winding; a battery operatively connected to the welding power supply; and a field controller operatively connected to the field winding. The method includes the step of simultaneously supplying electrical energy to the welding power supply by both of the engine-generator and the battery during a welding operation. The battery is recharged by the engine-generator through the welding power supply. The field controller monitors at least one of battery voltage and battery current of the battery during the recharging. The method includes the step of controlling, by the field controller during the recharging, a level of current flow through the field winding based on the at least one of the battery voltage and the battery current.

In certain embodiments, the step of controlling includes automatically adjusting the level of current flow through the field winding during the battery recharging based on the at least one of the battery voltage and the battery current. In certain embodiments, the method further comprises the step of selecting, by the field controller, one of a first field current level corresponding to a first recharging rate of the battery and a second field current level corresponding to a second recharging rate of the battery as the level of current flow through the field current winding, wherein the first field current level is greater than the second field current level and the first recharging rate is faster than the second recharging rate. In further embodiments, the first recharging rate exceeds a discharging rate of the battery during the welding operation, and the second recharging rate is approximately equal to the discharging rate of the battery during the welding operation. In further embodiments, the switching type power converter comprises a rectifier, a switching circuit and a DC bus connecting the rectifier and the switching circuit, wherein the battery is connected to the DC bus, and a voltage level of the DC bus due to excitation of the armature windings by the field winding at the first field current level is greater than the voltage level of the DC bus due to excitation of the armature windings by the field winding at the second field current level. In further embodiments, the method comprises the step of monitoring, by the field controller, an ambient temperature, wherein the field controller selects said one of the first field current level corresponding to the first recharging rate of the battery and the second field current level corresponding to the second recharging rate of the battery based on the ambient temperature. In further embodiments, the method comprises the step of monitoring, by the field controller, a battery temperature, wherein the field controller selects said one of the first field current level corresponding to the first recharging rate of the battery and the second field current level corresponding to the second recharging rate of the battery based on the battery temperature.

### BRIEF DESCRIPTION OF THE DRAWINGS

FIG. 1 is a schematic diagram of an example hybrid powered arc welding system;

FIG. 2 is a is a schematic diagram of an example hybrid powered arc welding system;

FIG. 3 is a is a schematic diagram of an example hybrid powered arc welding system;

FIG. 4 is a schematic diagram of a portion of an example hybrid powered arc welding system; and

FIG. 5 is a flow diagram of an example method of controlling battery recharging.

### DETAILED DESCRIPTION OF THE INVENTION

The present invention relates to hybrid powered arc welders having both a generator and a battery bank for supplying electrical power to the welder. The present invention will now be described with reference to the drawings, wherein like reference numerals are used to refer to like elements throughout. It is to be appreciated that the various drawings are not necessarily drawn to scale from one figure to another nor inside a given figure, and in particular that the size of the components are arbitrarily drawn for facilitating the understanding of the drawings. In the following description, for purposes of explanation, numerous specific details are set forth in order to provide a thorough understanding of the present invention. It may be evident, however, that the present invention can be practiced without these specific details. Additionally, other embodiments of the invention are possible and the invention is capable of being practiced and carried out in ways other than as described. The terminology and phraseology used in describing the invention is employed for the purpose of promoting an understanding of the invention and should not be taken as limiting.

As used herein, the term “welding” refers to an arc welding process. Example arc welding processes include shielded metal arc welding (SMAW) (e.g., stick welding), flux cored arc welding (FCAW), and other welding processes such as gas metal arc welding (GMAW), gas tungsten arc welding (GTAW), and the like.

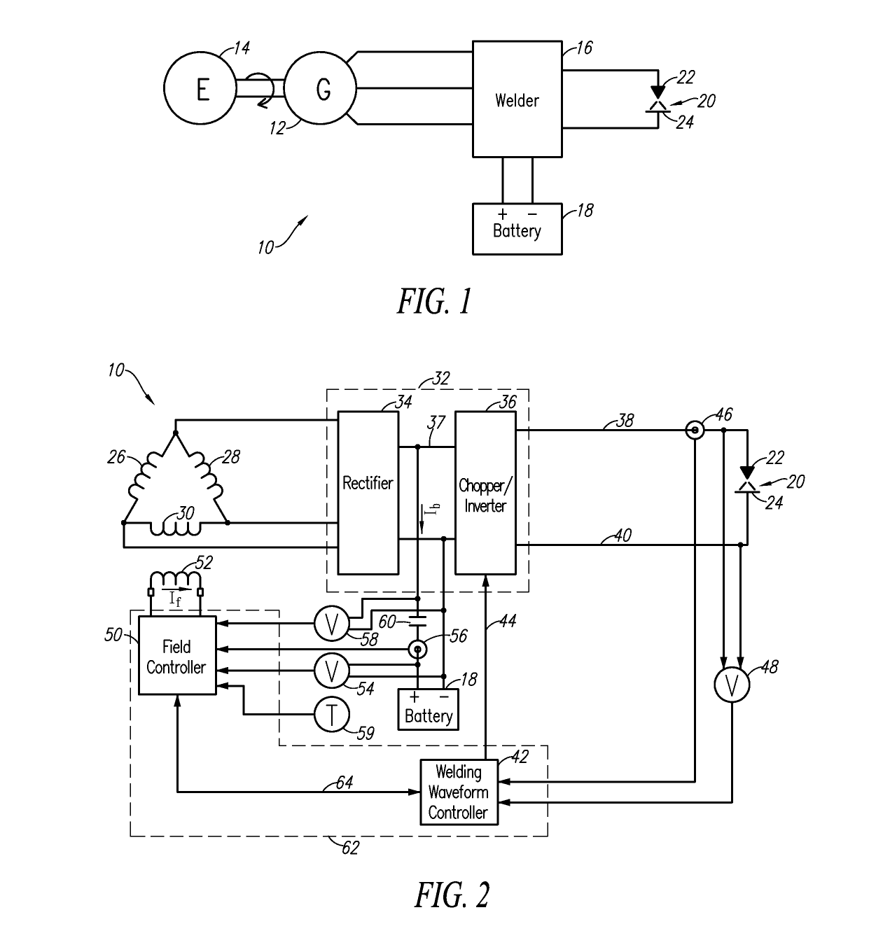

An example hybrid powered arc welding system 10 is shown schematically in FIG. 1. The welding system 10 includes a generator 12 driven by an engine 14 thereby forming an engine-generator. Example engines include diesel engines, gasoline engines, LP gas engines, and the like. The generator 12 generates electrical energy for powering a welding power supply 16 (hereinafter “welder”). The generator 12 is shown schematically as being a synchronous 3-phase alternator. However, the generator need not be a synchronous 3-phase alternator. For example, the generator could be a single phase alternator or a DC generator if desired.

The hybrid powered arc welding system 10 further includes a battery 18 operatively connected to the welder 16 for powering the welder. The battery 18 is typically in the form of a battery bank comprising a plurality of batteries connected so as to provide a DC voltage level suitable for arc welding (e.g., 80-100 VDC). The term “battery” as used herein refers to both individual batteries and banks of batteries (e.g., plural batteries connected in series). The welder 16 can be powered by the engine-generator alone, the battery 18 alone, or by the generator and battery simultaneously when performing a welding operation. A welding operation is schematically shown in FIG. 1 as an electric arc 20 extending between a welding electrode 22 (consumable or non-consumable) and a workpiece 24. Thus, the engine-generator and the battery can simultaneously supply the necessary electrical energy to the welder to produce the arc 20.

Hybrid powered arc welding systems can provide several advantages over conventional generator-powered welders. For example, when welding indoors, it can be desirable to weld using battery power only, without operating the engine. Further, a smaller engine can often be used in a hybrid system as compared to a conventional generator-powered system, while still delivering the same maximum welding current, since the maximum welding current will be supplied at least partially by the battery bank. A smaller engine can be considerably less expensive than a larger engine. For example, larger engines might have more expensive emissions controls than smaller engines. In the U.S., welders employing diesel engines of 25 HP and above will have to comply with the Environmental Protection Agency's Tier 4 Final (T4F) regulations. In view of the costs associated with the emissions controls required to meet the T4F regulations, it might be desirable to keep the engine below 25 HP. Thus, it can be beneficial to reduce the size of the engine.

As will be described in detail below, the engine-generator is configured to charge the battery 18 via the DC bus voltage within the welder 16, and the charging is controlled by regulating the generator's excitation field (hereinafter the “field”). By regulating the generator's field to control battery charging, the need for additional dedicated charging circuitry is reduced. The generator's field would be controlled by appropriate field control circuitry to control the generator's output voltage, regardless of whether the battery 18 was present. The welding system 10 exploits the field control circuitry, using it to also control battery charging, thereby minimizing the need for additional charging circuitry.

A more detailed schematic diagram of a hybrid powered arc welding system 10 is shown in FIG. 2. Three armature windings 26, 28, 30 in the generator supply electrical power to a switching type power converter 32 within the welder. The armature windings 26, 28, 30 would typically be located on a stator portion of the generator for excitation by a rotating field. A field winding 52 can be located on a rotor portion for generating a rotating excitation field. Alternatively, the armature windings could be located on the rotor portion and the field winding could be located on the stator portion if desired.

The welder 16 (FIG. 1) includes the switching type power converter 32. Example switching type power converters 32 include DC choppers, inverters, and the like. AC power from the generator is rectified by a rectifier 34 within the power converter. The DC output from the rectifier 34 supplies the welder's DC bus 37. The DC bus 37, in turn, supplies electrical power to a switching circuit, such as chopper or inverter 36. The DC bus 37 also supplies recharging power to the battery 18 from the engine-generator, as well as receives DC power from the battery to supply the chopper/inverter 36.

Electrical leads 38, 40 from the chopper/inverter 36 provide a completed circuit for the arc welding current. The arc welding current flows from the chopper/inverter 36 through the electrode 22, across the arc 20, and through the workpiece 24. The welding electrode 22 is operatively connected to the switching type power converter 32 via the electrical leads 38, 40, to receive electrical energy from the switching type power converter (as supplied by the engine-generator and/or battery) for producing the arc 20.

The welding system 10 includes a welding waveform controller 42. The welding waveform controller 42 is operatively connected to the switching type power converter 32 and provides a waveform control signal 44 to the switching type power converter 32. The welding waveform controller 42 controls the output of the switching type power converter 32 via the waveform control signal 44, to achieve a desired welding waveform, welding voltage, welding current, etc. The welding waveform controller 42 monitors various aspects of the welding process via feedback signals. For example, a current sensor, such as a current transformer (CT) 46 or shunt, can provide a welding current feedback signal to the welding waveform controller 42, and a voltage sensor 48 can provide a welding voltage feedback signal to the controller.

The welding waveform controller 42 can be an electronic controller and may include a processor. The welding waveform controller 42 can include one or more of a microprocessor, a microcontroller, a digital signal processor (DSP), an application specific integrated circuit (ASIC), a field-programmable gate array (FPGA), discrete logic circuitry, or the like. The welding waveform controller 42 can include a memory portion (e.g., RAM or ROM) storing program instructions that cause the controller to provide the functionality ascribed to it herein.

In addition to the welding waveform controller 42, the welding system 10 includes a field controller 50. The field controller 50 is connected to the generator's field winding and actively controls the electrical current (I_{f}) in the field winding 52, to thereby control the resulting DC bus 37 voltage. By adjusting or regulating the level of field current I_{f}, the voltage output of the generator can be controlled, to thereby control the DC bus 37 voltage. Excitation of the armature windings 26, 28, 30 by the field winding 52 at various field current I_{f} levels results in respective various different voltage levels at the DC bus 37. The field controller 50 uses its ability to control the DC bus 37 voltage according to the field current I_{f} to also control recharging of the battery 18 from the DC bus 37. That is, the field controller 50 controls battery recharging by controlling the field current I_{f}. While the engine-generator is operating, either during welding or between welding operations, the field controller 50 can control or adjust the level of field current I_{f} to cause the battery 18 to be recharged or to stop being recharged. At certain levels of field current I_{f}, the resulting DC bus voltage will be high enough to recharge the battery 18. At lower levels of field current I_{f}, the resulting DC bus voltage will be too low to charge the battery 18. The field controller 50 controls the level of field current I_{f} to control whether the battery 18 is recharged, and how quickly the battery is recharged.

The field controller 50 can automatically adjust or control the level of the field current during battery recharging based on the battery voltage and/or battery current during the recharging. The field controller 50 monitors battery voltage via a voltage sensor 54 and battery current I_{b} via a current sensor (CT 56). The voltage sensor 54 and current sensor respectively output signals to the field controller 50 corresponding to battery voltage and battery current. The field controller 50 can monitor the signals during normal operation of the welder and when the battery 18 is being recharged by the engine-generator. The field controller 50 can determine when the battery 18 is discharging (e.g., supplying electrical power during a welding operation) and when the battery is charging by the direction of the battery current flow. The field controller 50 can also monitor the DC bus 37 voltage via a voltage sensor 58. The field controller 50 can adjust the field current I_{f} to regulate the DC bus 37 voltage and/or the battery charging current I_{b}.

The field controller 50 can adjust the field current I_{f} within a given field current range. At the low end of the field current range, the resulting DC bus 37 voltage is lower than the battery voltage and the battery 18 is not charged. At the high end of the field current range, the resulting DC bus 37 voltage can provide a fast recharging of the battery 18. In the middle of the field current range, the resulting DC bus 37 voltage can provide a battery recharging rate that is approximately equal to the battery's discharging rate during welding (e.g., within 20% of the battery's discharging rate) or substantially equal to the battery's discharging rate during welding (e.g., within 10% of the battery's discharging rate), resulting in approximately or substantially a 50% duty cycle for the battery. In an example embodiment, the field controller 50 adjusts the field current I_{f} so that the field current is within the range of about 4 A to about 6.25 A; with a field current of approximately 5 A providing approximately a 50% duty cycle for the battery 18 at a charging current I_{b} of approximately 85 A.

The field controller 50 can control how quickly the battery 18 is recharged by adjusting the field current I_{f} to achieve a desired battery charging current I_{b}. How quickly the battery 18 is recharged determines the duty cycle of the battery. Quickly recharging the battery 18 results in a higher duty cycle for the battery, while slowly recharging the battery 18 results in a lower duty cycle. Lowering the duty cycle can extend battery life. In certain embodiments, the field controller 50 can control the field current I_{f} and battery recharging based on a desired duty cycle for the battery and/or a desired battery life.

The field controller 50 can control the level of the field current I_{f} during battery recharging based on different recharging rates for the battery 18 (e.g., fast, medium, slow, etc.) For example, the field controller 50 can selectively control the field current I_{f} at a first field current level corresponding to a first recharging rate or at a second field current level corresponding to second recharging rate. If the first field current level is greater than the second field current level, then the first recharging rate will be faster than the second recharging rate. For example, the first field current level can provide a fast recharging of the battery that exceeds the discharge rate of the battery during welding, thereby providing a battery duty cycle greater than 50%. The second field current level can provide a slower recharging of the battery that approximately equals the discharging rate of the battery during welding (i.e., providing approx. a 50% duty cycle) or that is slower than the discharging rate of the battery during welding (i.e., providing less than a 50% duty cycle). The field controller 50 can be configured to select among several different field current levels (e.g., three or more different field current levels) corresponding to respective different recharging rates or duty cycles for the battery. The selection can be made automatically by the field controller 50 or according to a user selection through an input on the welder 16 (FIG. 1). For example, the user can select among the several different recharging rates corresponding to respective different field current I_{f} levels through the input on the welder. Automatic selection of the field current I_{f} level by the field controller 50 can be based on a monitored condition, such as battery temperature or ambient temperature as discussed below.

In addition to monitoring battery voltage, battery current and DC bus 37 voltage, the field controller 50 can monitor ambient and/or battery temperature via a temperature sensor 59. The temperature sensor 59 is operatively connected to the field controller 50 to provide a temperature signal to the field controller. In certain embodiments, the field controller 50 selects or adjusts the field current I_{f} based on the ambient and/or battery temperature to thereby control the recharging rate of the battery 18 based on the ambient and/or battery temperature. At lower ambient/battery temperatures, the battery 18 can be recharged more quickly than at higher temperatures, without shortening the life of the battery. At higher ambient/battery temperatures, it can be desirable to recharge the battery 18 more slowly, to preserve the life of the battery. The field controller 50 can compare the observed temperature to one or more predefined temperature thresholds to determine a desired battery recharge rate and associated field current level. The field controller 50 can store the temperature threshold(s) in a memory portion of the field controller, and compare the temperature signal to the temperature threshold(s) and automatically select a field current level based on a result of comparing the temperature signal to the temperature threshold(s).

In certain embodiments, the field controller 50 can control the field current I_{f} and battery recharging based on a desired duty cycle for the battery, a desired battery life, and/or the ambient/battery temperature.

A switch, such as a contactor 60, is located along an electrical conductor between the battery 18 and the DC bus 37 to selectively disconnect the battery from the DC bus. The field controller 50 controls the operations of the contactor 60. The field controller 50 can disconnect the battery 18 from the DC bus 37 based on an abnormal condition. For example, if the battery voltage drops too low, the field controller 50 can operate the contactor 60 to disconnect the battery 18 from the DC bus 37. The battery 18 can also be disconnected from the DC bus 37 based on an abnormality or fault in the welding circuit, such as a short in the welding circuit.

The field controller 50 can be an electronic controller and may include a processor. The field controller 50 can include one or more of a microprocessor, a microcontroller, a digital signal processor (DSP), an application specific integrated circuit (ASIC), a field-programmable gate array (FPGA), discrete logic circuitry, or the like. The field controller 50 can include a memory portion (e.g., RAM or ROM) storing program instructions that cause the controller to provide the functionality ascribed to it herein.

The welding waveform controller 42 and the field controller 50 can be separate controllers. For example, the welding waveform controller 42 can be part of a dedicated control system for the power converter 32 to control a welding operation, while the field controller 50 can be part of a dedicated control system for the generator and/or engine. The welding waveform controller 42 and the field controller 50 can also be part of a common controller 62 for controlling operations of both of the power converter 32 and the generator and/or engine. In certain embodiments, the welding waveform controller 42 and the field controller 50 communicate over a communications bus 64. For example, the welding waveform controller 42 can communicate status information to the field controller 50, such as whether a welding operation is occurring, the welding current level, welding faults, etc.

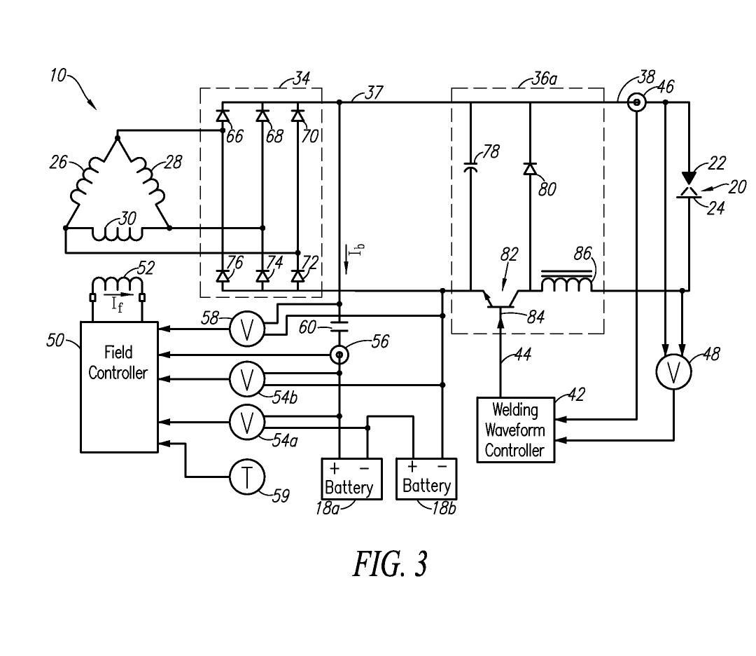

Turning to FIG. 3, FIG. 3 shows a schematic diagram of a hybrid powered arc welding system 10 including details of an example rectifier 34 and DC chopper circuit 36a. The rectifier 34 can be a three-phase, full-wave rectifier formed by a plurality of diodes 66, 68, 70, 72, 74, 76. It is to be appreciated that the rectifier 34 can be formed by semiconductor devices other than diodes, such as by thyristors controlled by the welding waveform controller 42.

In FIG. 3, the switching circuit that generates the welding waveform is a DC chopper circuit 36a (hereinafter “chopper”). The chopper includes a capacitor 78, a diode 80 and a controlled switch 82 (e.g., a transistor). The chopper 36a can further include a choke 86 for smoothing the welding current. The controlled switch 82 has a control input 84, such as a gate, that is operatively connected to the welding waveform controller 42. Operations of the controlled switch 82 are controlled via the waveform control signal 44 from the welding waveform controller 42, to thereby generate a desired welding waveform during a welding operation.

In embodiments in which the power converter comprises an inverter rather than a chopper 36a, the waveform control signal 44 can provide a pulse-width modulation (PWM) signal to the power converter.

The battery bank that is connected to the DC bus 37 comprises a plurality of batteries 18a, 18b. Although two batteries 18a, 18b are shown in FIG. 3, the battery bank would typically have more than two batteries, such as eight batteries for example, to provide the necessary DC welding voltage. The batteries are sized to provide a sufficient amount of welding current for a desired period of time, such as one hour for example, so that welding can occur with or without the engine running. The field controller 50 can monitor the voltage across each individual battery through a plurality of voltage sensors 54a, 54b. The welding system 10 can be configured to automatically start the engine to charge the batteries 18a, 18b based on the voltage level of one or more of the batteries 18a, 18b. The welding system 10 can also include a lockout switch to prevent the engine from running, such as when the welding system is located indoors. If the battery voltage drops too low, or if a fault in the welding circuit is detected by the welding waveform controller 42, the field controller 50 can operate the contactor 60 to disconnect the batteries 18a, 18b from the DC bus 37.

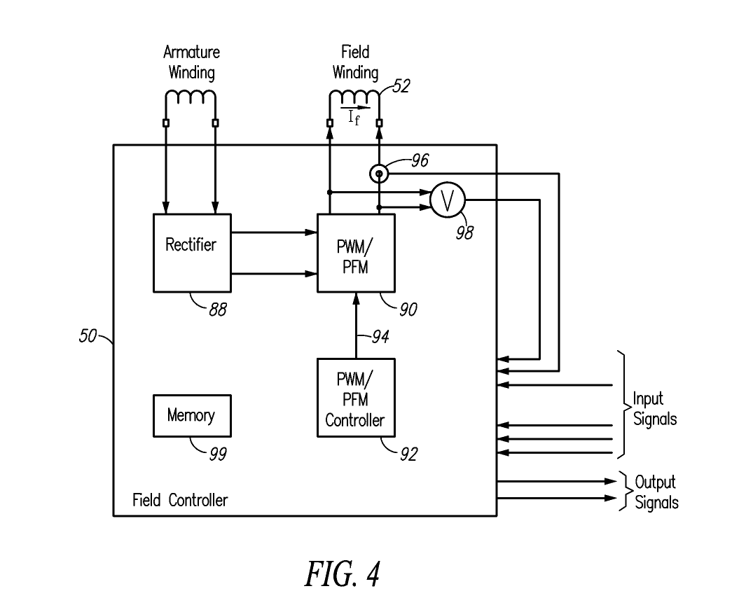

Turning to FIG. 4, FIG. 4 provides a schematic diagram of an example field controller 50. The field controller 50 receives power from an armature winding of the generator. The armature winding can be one of the windings that supplies power to the DC bus, or the armature winding can be an auxiliary winding of the generator. A rectifier 88 rectifies the AC voltage from the armature winding. The rectified voltage is provided to a pulse modulation switching device 90, such as a PWM or pulse-frequency modulation (PFM) switching device. The output of the pulse modulation switching device 90 is a pulse modulated signal (PWM or PFM) that generates the field current If in the field winding 52. The field controller 50 includes a PWM or PFM controller that provides a control signal 94 to the pulse modulation switching device 90, to thereby control the magnitude of the field current I_{f}. As discussed above, the field controller 50 receives various input signals such as battery voltage, battery current, DC bus voltage, ambient/battery temperature, etc. The field controller 50 can also monitor the field current I_{f} via a current sensor 96 and monitor the voltage across the field winding via a voltage sensor 98. The field controller 50 can control the field current If based some or all of the battery voltages, the battery current I_{b}, DC bus voltage, the ambient/battery temperature, the monitored field current level, and the voltage across the field winding. The field controller 50 can provide output signals to various devices, such as the contactor for disconnecting the battery bank from the DC bus. The field controller 50 further includes a memory portion 99 for storing program instructions, operating parameters, and the like.

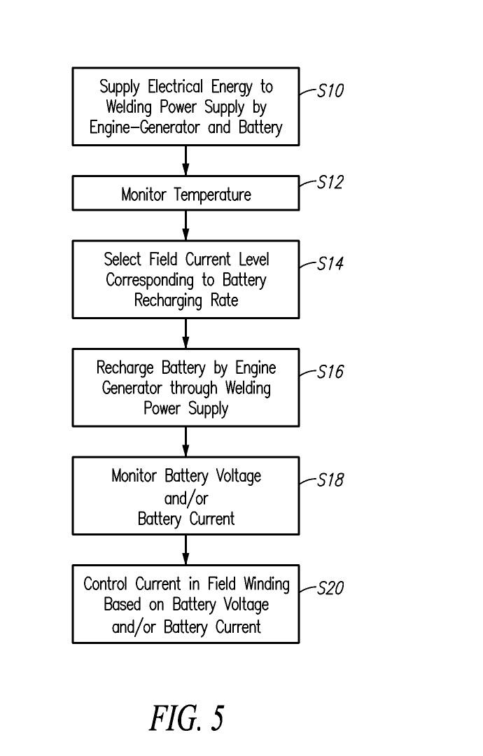

FIG. 5 is a flow diagram of an example method of controlling battery recharging in a hybrid powered arc welding system. Components of the hybrid powered arc welding system are discussed above. In step S10, electrical energy is supplied simultaneously to the welding power supply by both of the engine-generator and the battery during a welding operation. In step S12, the field controller monitors the ambient temperature and/or the battery temperature. In step S14, the field controller selects a field current level corresponding to a battery recharging rate. For example, the field controller can select between a first field current level corresponding to a first recharging rate of the battery and a second field current level corresponding to a second recharging rate of the battery. The selection can be based on the monitored ambient temperature and/or the battery temperature. The first field current level can be greater than the second field current level and the first recharging rate can be faster than the second recharging rate. For example, the first recharging rate can exceed a discharging rate of the battery during the welding operation, and the second recharging rate can be approximately equal to the discharging rate of the battery during the welding operation. In step S16, the battery is recharged by the engine-generator through the welding power supply; and in step S18 the field controller monitors battery voltage and/or battery current during recharging. In step S20, the field controller controls the level of field current during recharging based on the battery voltage and/or the battery current. Controlling the level of field current can include automatically adjusting the level of current flow through the field winding during recharging based on the battery voltage and/or the battery current.

It should be evident that this disclosure is by way of example and that various changes may be made by adding, modifying or eliminating details without departing from the fair scope of the teaching contained in this disclosure. The invention is therefore not limited to particular details of this disclosure except to the extent that the following claims are necessarily so limited.

What is claimed is:

1. An arc welding system, comprising:
a welding power supply comprising a switching type power converter;
a welding electrode operatively connected to the switching type power converter to receive electrical energy from the switching type power converter and produce an electric arc from the arc welding system;
an engine-generator operatively connected to the welding power supply to supply electrical energy to the welding power supply for producing the arc, the engine-generator comprising a plurality of armature windings for supplying the electrical energy to the welding power supply, and a field winding;
a battery operatively connected to the welding power supply to simultaneously supply further electrical energy to the welding power supply for producing the arc, and to receive electrical energy from the engine-generator through the welding power supply to recharge the battery;
a sensor configured to sense at least one of battery voltage and battery current and to output a signal during battery recharging corresponding to the at least one of battery voltage and battery current; and
a field controller operatively connected to the field winding of the engine-generator and to the sensor, wherein the field controller is configured to receive the signal from the sensor and to automatically adjust a level of current flow through the field winding during the battery recharging based on the signal from the sensor.

2. The arc welding system of claim 1, wherein the field controller provides a pulse modulated signal to the field winding to control the level of current flow through the field winding.

3. The arc welding system of claim 1, wherein the sensor is configured to sense battery current, and the field controller is configured to determine that the battery is recharging from a flow direction of the battery current.

4. The arc welding system of claim 1, wherein the field controller is configured to control the level of current flow through the field winding during the battery recharging based on one of a first field current level corresponding to a first recharging rate of the battery and a second field current level corresponding to second recharging rate of the battery, wherein the first field current level is greater than the second field current level and the first recharging rate is faster than the second recharging rate.

5. The arc welding system of claim 4, wherein the first recharging rate and the second recharging rate are user-selectable recharging rates.

6. The arc welding system of claim 4, wherein the first recharging rate exceeds a discharging rate of the battery during welding.

7. The arc welding system of claim 4, wherein the second recharging rate is approximately equal to a discharging rate of the battery during welding.

8. The arc welding system of claim 4, wherein the switching type power converter comprises a rectifier, a switching circuit and a DC bus connecting the rectifier and the switching circuit, wherein the battery is connected to the DC bus, and a voltage level of the DC bus due to excitation of the armature windings by the field winding at the first field current level is greater than the voltage level of the DC bus due to excitation of the armature windings by the field winding at the second field current level.

9. The arc welding system of claim 4, further comprising a temperature sensor operatively connected to the field controller to provide a temperature signal to the field controller, wherein the field controller is configured to automatically select one of the first field current level corresponding to the first recharging rate of the battery and the second field current level corresponding to the second recharging rate of the battery based on the temperature signal, and to control the level of current flow through the field winding during battery recharging based on the selected one of the first field current level and the second field current level.

10. The arc welding system of claim 9, wherein the field controller stores a temperature threshold and compares the temperature signal to the temperature threshold, and automatically selects said one of the first field current level and the second field current level based on a result of comparing the temperature signal to the temperature threshold.

11. An arc welding system, comprising:
a welding power supply comprising a switching type power converter;
a welding electrode operatively connected to the switching type power converter to receive electrical energy from the switching type power converter and produce an electric arc from the arc welding system;
an engine-generator operatively connected to the welding power supply to supply electrical energy to the welding power supply for producing the arc, the engine-generator comprising a plurality of armature windings for supplying the electrical energy to the welding power supply, and a field winding;
a battery operatively connected to the welding power supply to simultaneously supply further electrical energy to the welding power supply for producing the arc, and to receive electrical energy from the engine-generator through the welding power supply to recharge the battery;
a sensor configured to sense at least one of battery voltage and battery current and to output a signal during battery recharging corresponding to the at least one of battery voltage and battery current; and
a field controller operatively connected to the field winding of the engine-generator and to the sensor, wherein the field controller is configured to receive the signal from the sensor and to control a level of current flow through the field winding during the battery recharging based on the signal from the sensor, wherein the field controller is configured to control the level of current flow through the field winding during the battery recharging to be one of a first field current level corresponding to a first recharging rate of the battery and a second field current level corresponding to second recharging rate of the battery, wherein the first field current level is greater than the second field current level and the first recharging rate is faster than the second recharging rate.

12. The arc welding system of claim 11, wherein the field controller provides a pulse modulated signal to the field winding to control the level of current flow through the field winding.

13. The arc welding system of claim 11, wherein the sensor is configured to sense battery current, and the field controller is configured to determine that the battery is recharging from a flow direction of the battery current.

14. The arc welding system of claim 11, wherein the first recharging rate and the second recharging rate are user-selectable recharging rates.

15. The arc welding system of claim 11, wherein the first recharging rate exceeds a discharging rate of the battery during welding.

16. The arc welding system of claim 11, wherein the second recharging rate is approximately equal to a discharging rate of the battery during welding.

17. The arc welding system of claim 11, wherein the switching type power converter comprises a rectifier, a switching circuit and a DC bus connecting the rectifier and the switching circuit, wherein the battery is connected to the DC bus, and a voltage level of the DC bus due to excitation of the armature windings by the field winding at the first field current level is greater than the voltage level of the DC bus due to excitation of the armature windings by the field winding at the second field current level.

18. The arc welding system of claim 11, further comprising a temperature sensor operatively connected to the field controller to provide a temperature signal to the field controller, wherein the field controller is configured to automatically select one of the first field current level corresponding to the first recharging rate of the battery and the second field current level corresponding to the second recharging rate of the battery based on the temperature signal, and to control the level of current flow through the field winding during battery recharging based on the selected one of the first field current level and the second field current level.

19. The arc welding system of claim 18, wherein the field controller stores a temperature threshold and compares the temperature signal to the temperature threshold, and automatically selects said one of the first field current level and the second field current level based on a result of comparing the temperature signal to the temperature threshold.

20. A method of controlling battery recharging in a hybrid powered arc welding system, comprising the steps of:
providing the arc welding system, wherein the arc welding system comprises:
a welding power supply comprising a switching type power converter;
a welding electrode operatively connected to the switching type power converter;
an engine-generator operatively connected to the welding power supply, the engine-generator comprising a plurality of armature windings and a field winding;
a battery operatively connected to the welding power supply; and
a field controller operatively connected to the field winding;
simultaneously supplying electrical energy to the welding power supply by both of the engine-generator and the battery during a welding operation;
recharging the battery by the engine-generator through the welding power supply;
monitoring, by the field controller, at least one of battery voltage and battery current of the battery during the recharging; and
controlling, by the field controller during the recharging, a level of current flow through the field winding based on the at least one of the battery voltage and the battery current.

21. The method of claim 20, wherein the step of controlling includes automatically adjusting the level of current flow through the field winding during the battery recharging based on the at least one of the battery voltage and the battery current.

22. The method of claim 20, further comprising the step of selecting, by the field controller, one of a first field current level corresponding to a first recharging rate of the battery and a second field current level corresponding to a second recharging rate of the battery as the level of current flow through the field current winding, wherein the first field current level is greater than the second field current level and the first recharging rate is faster than the second recharging rate.

23. The method of claim 22, wherein the first recharging rate exceeds a discharging rate of the battery during the welding operation, and the second recharging rate is approximately equal to the discharging rate of the battery during the welding operation.

24. The method of claim 22, wherein the switching type power converter comprises a rectifier, a switching circuit and a DC bus connecting the rectifier and the switching circuit, wherein the battery is connected to the DC bus, and a voltage level of the DC bus due to excitation of the armature windings by the field winding at the first field current level is greater than the voltage level of the DC bus due to excitation of the armature windings by the field winding at the second field current level.

25. The method of claim 22, further comprising the step of monitoring, by the field controller, an ambient temperature, wherein the field controller selects said one of the first field current level corresponding to the first recharging rate of the battery and the second field current level corresponding to the second recharging rate of the battery based on the ambient temperature.

26. The method of claim 22, further comprising the step of monitoring, by the field controller, a battery temperature, wherein the field controller selects said one of the first field current level corresponding to the first recharging rate of the battery and the second field current level corresponding to the second recharging rate of the battery based on the battery temperature.
